(19) United States
(12) Patent Application Publication
(10) Pub. No.: US 2005/0011303 A1
(43) Pub. Date: Jan. 20, 2005

(54) Bicycle crank with flatter cross section

(76) Inventors: Douglas Chiang, Dali City (TW); David Michael Anthony, Dali City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/618,969

(22) Filed: Jul. 14, 2003

(51) Int. Cl. G05G 1/14

(52) U.S. Cl. 74/594.1

(57) ABSTRACT

A bicycle crank includes a connection end for being connected to an axle of bottom bracket and a remote end for being connected to a pedal. The remote end extends off from a longitudinal axis of the crank. A first side of the crank has a thick and rounded configuration and a second side has a narrow configuration.

### FIELD OF THE INVENTION

The present invention relates to a bicycle crank that has a connection end and a remote end, one side of the crank is thick and rounded and the other side which faces forward direction is narrowed.

### BACKGROUND OF THE INVENTION

A conventional bicycle crank is disclosed in FIG. 9 and generally includes a connection end so as to connect to the axle in the bottom bracket, and a remote end which is connected to a pedal. The rider treads the pedals to rotate the sprocket to let the bicycle move forward. The crank on the right side and the crank on the left side are identical and both of which have a rectangular cross section so that when the cranks are rotated, the cross section facing the forward direction is suffered a large resistance caused by air flow. This conventional crank is not satisfied for a bicycle used in a highly competition racing situation because a tiny extra resistance could change the result.

The present invention intends to provide a crank that has a narrow front side and a thick and rounded rear side so that the air resistance can be reduced.

### SUMMARY OF THE INVENTION

In accordance with one aspect of the present invention, there is provided a bicycle crank which has a gradually reduced cross section from the connection end for connected to the bottom bracket, to the remote end for connected to a pedal. The narrow side facing forward so as to reduce the air resistance during riding.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a side view to show the crank on one side of bicycle of the present invention;

FIGS. 2-1, 2-2 and 2-3 show three cross sections of the crank;

FIG. 3 is a perspective view to show the crank of the present invention;

FIG. 4 is a side view to show the crank on the other side of bicycle of the present invention;

FIGS. 5-1, 5-2 and 5-3 show three cross sections of the crank as shown in FIG. 4;

FIG. 6 is a perspective view to show the crank disclosed in FIG. 4 of the present invention;

FIGS. 7 and 8 show the two cranks are in two positions when riding the bicycle, and

FIG. 9 shows a conventional crank.

### DETAILED DESCRIPTION OF THE PREFERRED EMBODIMENT

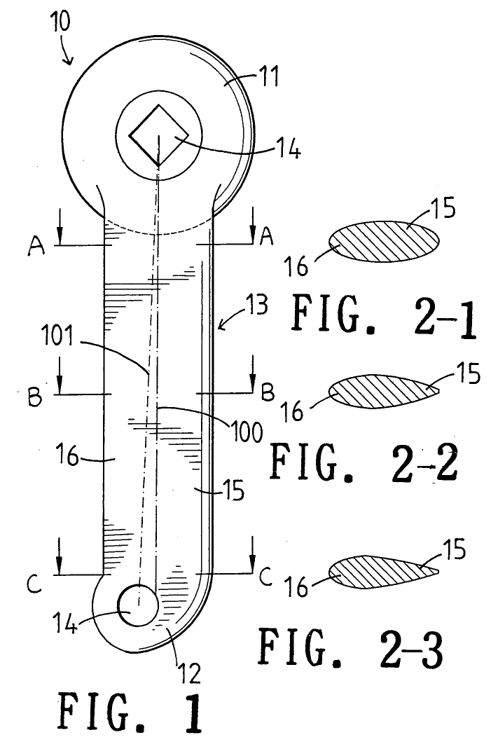

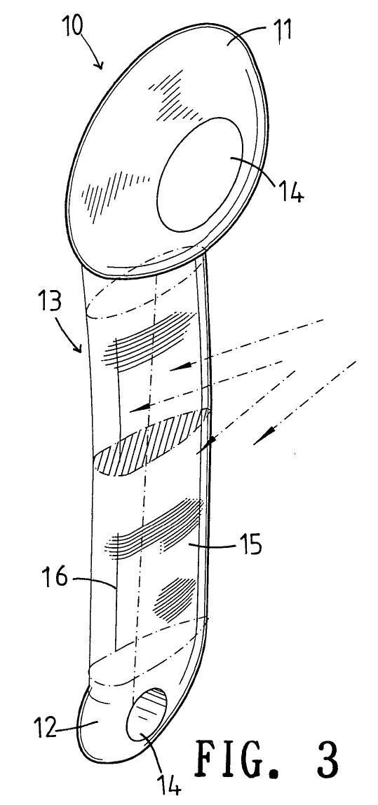

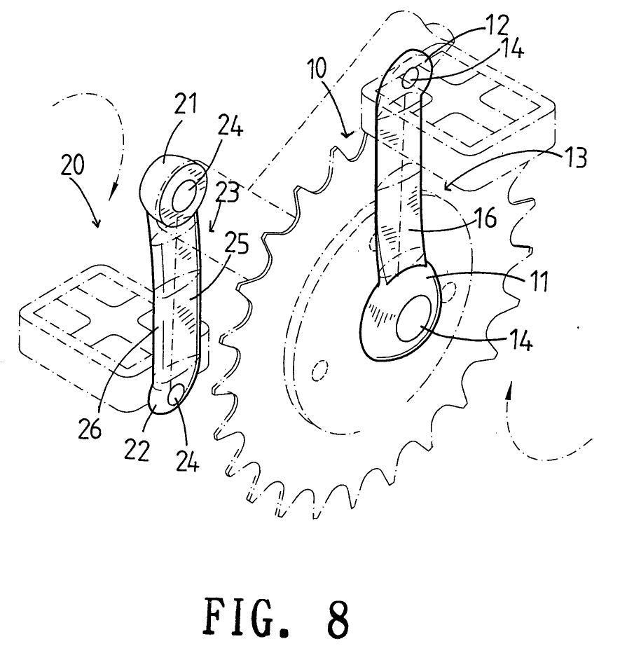

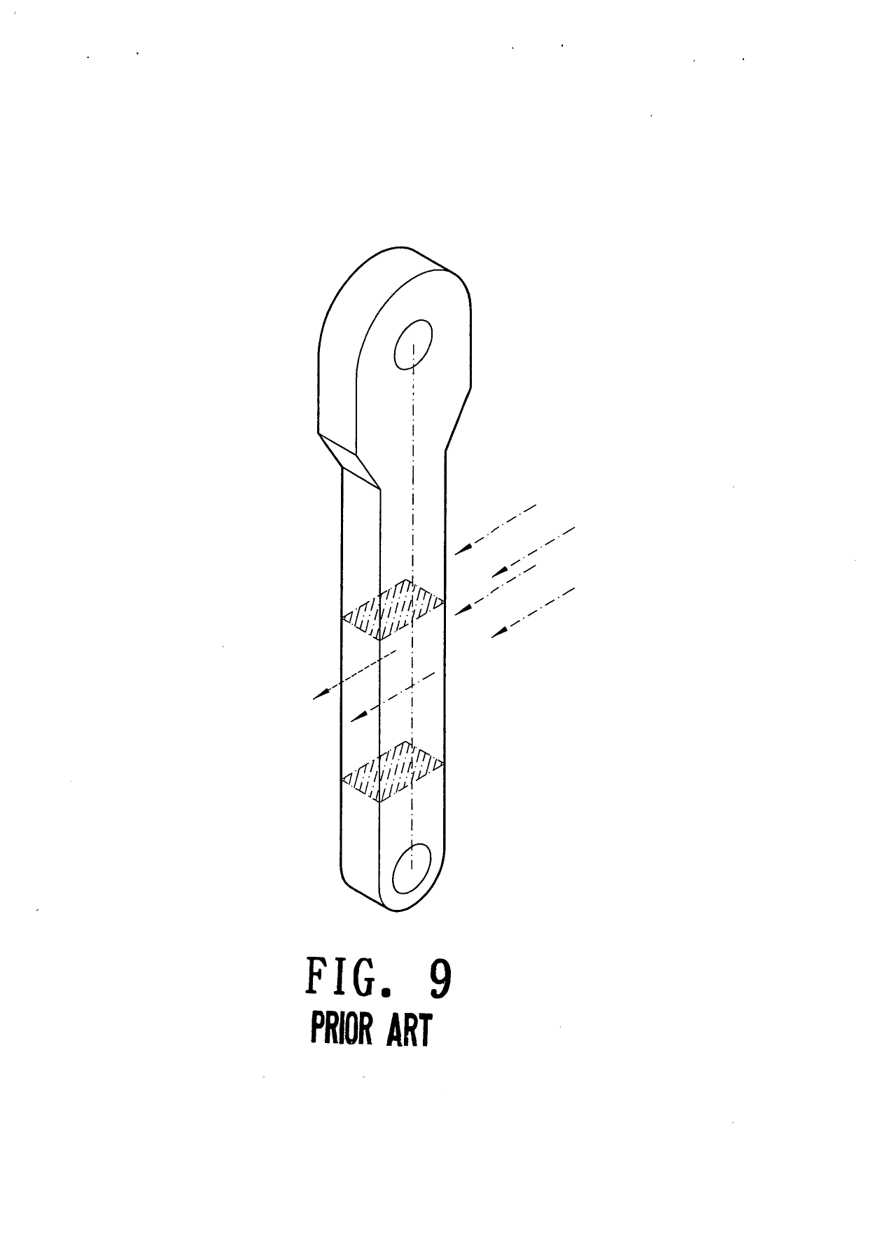

Referring to FIGS. 1 to 3, the crank 10 on one side of a bicycle of the present invention comprises a shank 13 which has a connection end 11 for being connected to an axle of bottom bracket as shown in FIG. 7, and a remote end 12 for being connected to a pedal as shown in FIG. 7. The shank 13 has a first side 16 which has a thick and rounded configuration and a second side 15 which has a narrow configuration. The remote end 12 is in a form of a protrusion which extends off from a longitudinal axis 100 of the shank 13 and away from the second side 15.

A first hole 14 is defined in a center of the connection end 11 such that the axle of the bottom bracket is engaged, and a second hole 14 is defined through the remote end 12 for the shaft (not shown) of the pedal being engaged. An included angle is defined between the longitudinal axis 100 of the shank 13 and a line 101 connected between a center of the first hole 14 and a center of the second hole 14. The shank 13 has a gradually reduced cross section from the first side 16 to the second side 15. In other words, any cross section of the shank 13 has a thick and rounded first side and a narrow second side. Referring to FIGS. 2-1, 2-2 and 2-3, each cross section of the shank 13 tapered toward the second side 15 at the points where the connection axis 101 intersects the periphery of the cross section.

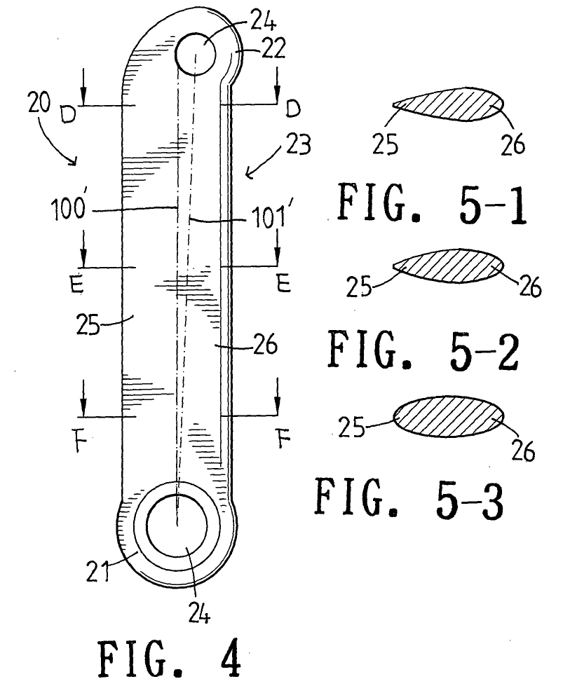

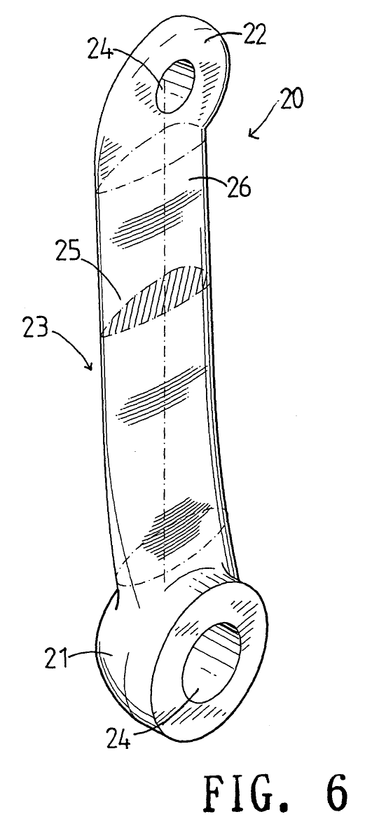

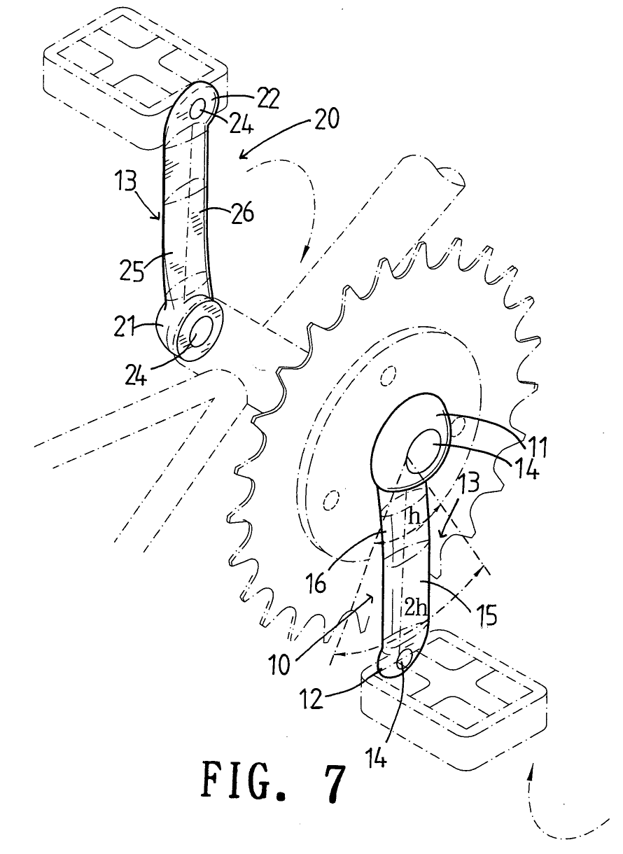

FIGS. 4 and 6 show the other crank 20 on the other side of bicycle and includes a shank 23 with a connection end 21 for being connected to an axle of bottom bracket as shown in FIG. 7, and a remote end 22 for being connected to a pedal as shown in FIG. 7. The shank 23 has a first side 26 which has a thick and rounded configuration and a second side 25 which has a narrow configuration. The remote end 22 is in a form of a protrusion which extends off from a longitudinal axis 100′ of the shank 23 and away from the second side 25.

A third hole 24 is defined in a center of the connection end 21 such that the axle of the bottom bracket is engaged, and a fourth hole 24 is defined through the remote end 22 for the shaft (not shown) of the pedal being engaged. An included angle is defined between the longitudinal axis 100′ of the shank 23 and a line 101′ connected between a center of the first hole 24 and a center of the second hole 24. The shank 23 has a gradually reduced cross section from the first side 26 to the second side 25. In other words, any cross section of the shank 23 has a thick and rounded first side 26 and a narrow second side 25. Referring to FIGS. 5-1, 5-2 and 5-3, each cross section of the shank 23 is tapered toward the second side 25 at the points where the connection axis 101′ intersects the periphery of the cross section.

Referring to FIGS. 7 and 8, when rotating the cranks 10 and 20, the narrow second sides 13 and 25 always cut the air, thereby reducing the air resistance during riding. The protrusions on the remote ends 12, 22 allows air smoothly slip away from the shank 13, 23 via the protrusions which extend rearward when riding.

While we have shown and described the embodiment in accordance with the present invention, it should be clear to those skilled in the art that further embodiments may be made without departing from the scope of the present invention.

1. A bicycle crank comprising:
a shank which has a connection end adapted to be connected to an axle of bottom bracket, and a remote end adapted to be connected to a pedal, the remote end being a protrusion extending off from a longitudinal axis of the shank, a first hole defined in a center of the connection end and a second hole defined through the remote end, an included angle defined between the longitudinal axis of the shank and a line connected between a center of the first hole and a center of the second hole, a cross section of the shank having a first side which has a thick and rounded configuration and a second side which has a narrow configuration.

2. The crank as claimed in claim 1, wherein each cross section of the shank tapered toward the second side at the points where the connection axis intersects the periphery of the cross section.

3. The crank as claimed in claim 1, wherein the protrusion of the remote end extends away from the second side.
